(19) United States
(12) Patent Application Publication
(10) Pub. No.: US 2017/0275435 A1
(43) Pub. Date: Sep. 28, 2017

(54) RESIN COMPOSITION, MOLDED PRODUCT OF RESIN COMPOSITION, AND JOINT STRUCTURE OF MOLDED PRODUCT OF RESIN COMPOSITION

(71) Applicant: FUJI JUKOGYO KABUSHIKI KAISHA, TOKYO (JP)

(72) Inventor: Ryuji SHIOZAKI, Tokyo (JP)

(21) Appl. No.: 15/443,252

(22) Filed: Feb. 27, 2017

(30) Foreign Application Priority Data
Mar. 28, 2016 (JP) 2016-063203

(51) Int. Cl. C08K 3/20; B32B 7/12; B32B 27/08; B32B 27/34; C08K 7/02; C08J 7/06

(52) U.S. Cl. CPC C08K 3/20; C08K 7/02; C08J 7/06; B32B 27/08; B32B 27/34; B32B 7/12; C08J 2377/02; B32B 2255/10; B32B 2255/20

(57) ABSTRACT

A resin composition includes a polyamide resin, and a graphene oxide.

### CROSS-REFERENCE TO RELATED APPLICATIONS

The present application claims priority from Japanese Patent Application No. 2016-063203 filed on Mar. 28, 2016, the entire contents of which are hereby incorporated by reference.

### BACKGROUND

1. Technical Field

The present invention relates to a resin composition, and relates particularly to a resin composition containing a polyamide resin and having excellent mechanical properties and heat resistance, a molded product of the resin composition, and a joint structure of a molded product of the resin composition.

2. Related Art

Polyamide resins such as nylon 6 and nylon 66 have the properties of excellent mechanical properties, heat resistance, etc., and are widely used as engineering plastics.

However, in even a polyamide resin having excellent heat resistance, heat-aging in which the resin reacts with atmospheric oxygen during heating and deteriorates occurs in cases of being continually exposed to high temperatures over a long period of time as in use for automobile components.

It is said that heat aging occurs due to the fact that peroxide radicals that are formed by the reaction between radicals produced on the backbone carbon of the resin due to heating and oxygen cut polymer chains continually.

A technology of adding a heat stabilizer to a resin for the purpose of suppressing the heat aging of the resin is disclosed in Japanese Unexamined Patent Application Publication (JP-A) No. 2009-235352. Specifically, JP-A No. 2009-235352 discloses a polyamide resin composition in which a copper halogenide is blended as a heat stabilizer in a polyamide resin that uses a source material derived from biomass.

Other than the copper halogenide described in JP-A No. 2009-235352, adding a phenol compound as a heat stabilizer to a polyamide resin composition has conventionally been performed.

In the case where the molded product of the polyamide resin composition is a component of a product in which a plurality of components are combined, it is necessary that adhesive performance to another component be good. Examples of such adhesive performance include adhesive performance to a silicone-based sealing member interposed at the joint between components.

However, although heat aging is suppressed by the polyamide resin composition of JP-A No. 2009-235352 by virtue of the copper halogenide, the literature does not give any description of the adhesive performance of a molded product formed by molding the polyamide resin composition. A phenol-based compound used as a heat stabilizer is treated in a similar way.

Furthermore, adding the additive mentioned above into a polyamide resin may influence the strength of a molded product of the polyamide resin.

### SUMMARY OF THE INVENTION

It is desirable to provide a resin composition that has both heat stability and good adhesive performance to a silicone-based sealing material without impairing the strength of a molded product after molding, a molded product of the resin composition, and a joint structure of a molded product of the resin composition can be provided.

An aspect of the present invention provides a resin composition including a polyamide resin, and a graphene oxide.

According to the above structure, the resin composition is provided with heat stability and good adhesive performance to a silicone-based sealing material by a graphene oxide. Furthermore, the strength of a molded product after molding is not impaired.

The resin composition of the present invention may have the following features.

(1) A degree of oxidation of the graphene oxide may be more than or equal to 10% and less than or equal to 70%
(2) A proportion of the graphene oxide blended may be more than or equal to 0.1 mass % and less than or equal to 3 mass % relative to a total mass of the resin composition.
(3) Fibers may be included as a reinforcing material in a maximum amount of 60 mass % relative to the total mass of the resin composition.

An aspect of the present invention provides a molded product of the resin composition.

An aspect of the present invention provides a joint structure of a molded product of a resin composition. The molded product and a member to be joined to the molded product may be joined together via a cured substance of a liquid curable silicone rubber composition.

An aspect of the present invention provides a coated body. A surface of a molded object of a polyamide resin composition may be coated with an outer skin material containing a graphene oxide.

### DETAILED DESCRIPTION

Hereinafter, preferred implementations of the present invention will be described in detail.

### [Resin Composition and Molded Product of the Resin Composition]

A resin composition of an implementation of the present invention contains a polyamide resin and a graphene oxide.

For the polyamide resin, an n-nylon synthesized by the condensation polymerization reaction of an w-amino acid or an n,m-nylon synthesized by the condensation copolymerization reaction of a diamine and a dicarboxylic acid may be used.

Examples of the n-nylon include nylon-6, nylon-11, and nylon-12. Examples of the n,m-nylon include nylon 66, nylon 610, nylon 6T, nylon 61, nylon 9T, and nylon M5T.

A graphene oxide has a structure in which an oxygen-containing group such as a hydroxyl group, an epoxy group, or a carboxyl group is added to a graphene sheet having a structure in which six-membered rings based on sp2 carbon are spread over. The degree of oxidation of the graphene oxide that can be used for the resin composition of an implementation of the present invention is more than or equal to 10% and less than or equal to 70%, and preferably more than or equal to 50% and less than or equal to 55%. If the degree of oxidation is more than 70%, the amount of hydroxyl groups is excessive, and the compatibility with the polyamide resin is impaired and molding is made difficult. If the degree of oxidation is less than 10%, the amount of hydroxyl groups is small, and therefore the adhesive performance to a silicone-based sealing member is reduced and also heat stability is reduced.

In the specification of the present application, the degree of oxidation of the graphene oxide refers to the ratio in percentage of molar concentration of oxygen atoms to carbon atoms in the graphene oxide. The ratio of molar concentration of oxygen atoms to carbon atoms in the graphene oxide can be found by X-ray photoelectron spectroscopy.

The proportion of the graphene oxide blended is more than or equal to 0.1 mass % and less than or equal to 3 mass % and preferably more than or equal to 0.1 mass % and less than or equal to 1 mass % relative to the total mass of the resin composition of an implementation of the present invention.

If the proportion of the graphene oxide blended is less than 0.1 mass %, it is difficult to effectively suppress the heat aging of the molded product of the resin composition, and the adhesive performance to a silicone-based sealing material is greatly reduced. If the proportion of the graphene oxide blended is more than 3 mass %, the amount of the additive is large, and the strength of the resin molded product is reduced. Furthermore, due to the excessive addition of graphene, the breaking of the resin matrix will occur, and consequently the suppression of heat aging and the adhesive performance to a silicone-based sealing material are reduced.

Fibers may be further incorporated as a reinforcing material into the resin composition of an implementation of the present invention. The fibers may be glass fibers, carbon fibers, ceramic fibers (alumina fibers, silicon carbide fibers, etc.), asbestos fibers, or metal fibers (stainless steel fibers, aluminum fibers, brass fibers, etc.). Glass fibers and carbon fibers are preferable.

The fibers may be incorporated in a maximum amount of 60 mass % relative to the total mass of the resin composition. If the amount is more than 60 mass %, it is difficult to produce a molded product by injection molding. From the viewpoint of improving the initial strength of the molded product of the resin composition, the fibers are preferably incorporated in an amount of 15 mass % or more relative to the total mass of the resin composition.

Further, various additive materials may be incorporated into the resin composition of an implementation of the present invention to the extent that the effect of the implementation of the present invention is not impaired. The various additive materials may be an organic or inorganic pigment, dye, or plasticizer, a lubricant such as a fatty acid, a fatty acid salt, or a fatty acid amide, a foaming agent, a fire retardant such as a phosphoric acid ester, an ultraviolet absorbent, an antistatic agent such as a monoglyceride, a crystal nucleating agent such as an organic phosphorus compound, a mold release agent such as a silicone-based compound, or a heat stabilizer such as a phenol-based compound. Simply one of these may be added, or two or more of these may be added.

Examples of the method for producing the resin composition of an implementation of the present invention include a method in which fibers as a reinforcing material and a graphene oxide are introduced into a polyamide resin in a molten state and kneading is performed in a kneader or melt-kneading is performed in an extruder. In this case, various additives may be added into the polyamide resin in a molten state as appropriate. From the viewpoint of productivity improvement, performing melt-kneading in a continuous extruder is preferable to in a batch-type kneader.

It is also possible to melt pellets of a mixed composition in which a polyamide resin and fibers (a reinforcing material) are mixed in advance, introduce a graphene oxide into the molten substance, and perform kneading.

A conventionally known molding method may be used as the method for producing a molded product of the resin composition of an implementation of the present invention. Examples include the injection molding method, extrusion molding method, press molding method, vacuum molding method, and blow molding method.

Examples of the molded product of the resin composition of an implementation of the present invention include, as vehicle components, a chain cover, an intake manifold, a cylinder head cover, a timing belt cover, an intercooler tank, an oil reservoir tank, an oil pan, an oil strainer, a canister, a protector, a bumper, a fender, an engine hood, etc.

### [Joint Structure of a Molded Product of the Resin Composition]

An implementation of the present invention further provides a joint structure of a molded product of a resin composition in which a molded product of the resin composition of an implementation of the present invention and a member to be joined to the molded product are joining together via a cured substance of a liquid curable silicone rubber composition.

Examples of the member to be joined to the molded product of an implementation of the present invention include not only a molded product made of a resin but also a metal molded product etc. The metal contained in the metal molded product may be cast iron, aluminum, magnesium alloy, or the like.

As the liquid curable silicone rubber composition, a known composition commercially available as a liquid gasket (a formed-in-place gasket (FIPG)) may be used. The FIPG is a gasket that is applied to the joining surface of one of members to be joined together and is cured with care while both members are kept in contact with pressure via the joining surfaces. Examples include moisture curable silicone and two-liquid-mixing curable silicone.

Next, a method for producing a joint structure of a molded product of the resin composition of an implementation of the present invention is described.

First, a liquid curable silicone rubber composition is applied to at least one of the joining surface of a molded product of the resin composition of an implementation of the present invention and a member to be joined, and both members are brought into contact with pressure via the liquid curable silicone rubber composition. The liquid silicone rubber composition is cured in this state, and thereby the molded product of the resin composition and the member to be joined are joined together; thus, a joint structure of the molded product of the resin composition of an implementation of the present invention can be obtained.

By the joint structure of the molded product of the resin composition, the heat aging of the molded product can be suppressed by a graphene oxide being added in the resin composition forming the molded product. Furthermore, by a graphene oxide being added, the adhesiveness between the molded product and the cured substance of the liquid curable silicone rubber composition is improved, and a more strong joint structure of the molded product and the member to be joined can be obtained.

The joint structure of the molded product of the resin composition of an implementation of the present invention may be a joint structure of a vehicle component of the examples mentioned above and a vehicle framework member.

[Coated Body in which the Surface of a Molded Object of a Polyamide Resin Composition is Coated with an Outer Skin Material Containing a Graphene Oxide]

An implementation of the present invention further provides a coated body in which the surface of a molded object of a polyamide resin composition is coated with an outer skin material containing a graphene oxide.

The polyamide resin composition may be a composition in which the graphene oxide is removed from the resin composition of an implementation of the present invention mentioned above.

The outer skin material containing a graphene oxide may be a coating material or a film in which a graphene oxide is dispersed. The coating material containing a graphene oxide can be obtained by dispersing a graphene oxide in a photocurable (e.g. ultraviolet curable) modified nylon coating material provided with polarity. Commercially available ones may be used as such a modified nylon coating material.

The film containing a graphene oxide can be obtained by, for example, melt-kneading a material in which a graphene oxide is added up to the same composition as the resin composition of an implementation of the present invention and pushing out the melt-kneaded material by the T-die method. Extension processing may be performed as necessary. The resin composition used for the production of the film may not necessarily be exactly the same composition as the resin composition of an implementation of the present invention, and may be a composition in which the fibers (a reinforcing agent) are removed, for example.

The method for producing the coated body in which the surface of a molded object of a polyamide resin composition is coated with an outer skin material containing a graphene oxide may be (i) a method of forming a molded object of a polyamide resin composition and coating the surface of the molded object with a film or a coating material containing a graphene oxide or (ii) a method of putting a film and a polyamide resin composition into a mold and coating the surface of the polyamide resin composition with the film and at the same time performing molding.

The former (i) is called the secondary decorating, and the latter (ii) is called the primary decorating.

With regard to (i), the formation of the molded object of a polyamide resin composition may use a conventionally known molding method (e.g. the injection molding method, extrusion molding method, press molding method, vacuum molding method, or blow molding method). In the case where a molded object is formed and then the surface of the molded object is coated with a film, the film can be applied to the surface of the molded object by overlay molding or the three-dimension overlay method (TOM). In the case where a molded object is formed and then the surface of the molded object is coated with a coating material, various application methods such as spraying coating, roller coating, a roll coater, electrostatic coating, powder coating, and ultraviolet curing coating may be used. The applied coating material is fixed by curing treatment or the like.

With regard to (ii), a coated body in which the surface of a molded object of a polyamide resin composition is coated with an outer skin material containing a graphene oxide can be obtained by injection molding in which a film containing a heat stabilizer is inserted into a mold and then a polyamide resin composition is injected into the mold, alternatively injection press molding in which a polyamide resin composition is injected into a mold and then pressing is performed, or the like.

The present invention will now be further described in detail using Examples.

### EXAMPLES

### 1. Production of Resin Compositions

### Example 1

PA-6-GF30-01 (produced by Daicel Polymer Ltd.), which is a polyamide 6 resin in which glass fibers are added at 30 mass %, and a graphene oxide (produced by Tokyo Chemical Industry Co., Ltd; model number: G0443; 0.1 mass % relative to the total mass of the resin composition) were melt-kneaded into pellets using a twin-screw kneading extruder (HK25D-41, manufactured by Parker Corporation, Inc.).

### Examples 2 and 3

Pellets of resin compositions were prepared in a similar manner to Example 1 except that the amount of the graphene oxide added was altered to 1 mass % (Example 2) and 3 mass % (Example 3) relative to the total mass of the resin composition.

### Comparative Examples 1 and 2

Pellets of resin compositions were prepared in a similar manner to Example 1 except that the amount of the graphene oxide added was altered to 0 mass % (Comparative Example 1) and 10 mass % (Comparative Example 2) relative to the total mass of the resin composition.

### 2. Production of Molded Products of Resin Compositions

The pellets obtained in “1. Production of resin compositions” were dried at 80° C. under reduced pressure for 4 hours, and injection molding was performed using an injection molding machine (PNX-III, manufactured by Nissei Plastic Industrial Co., Ltd.; the temperatures: cylinder, C1=230° C., C2=240° C., C3=250° C., nozzle=240° C., resin=250° C., mold=60° C.); thus, test pieces in accordance with JIS K 7161 and test pieces in accordance with ISO 19095-3 were obtained.

The following evaluation tests were performed on each test piece; the results are illustrated in Table 1.

### 3. Evaluation Tests

### 3-1. Test of Plastic-Tensile Properties

A test of plastic-tensile properties in accordance with JIS K 7161 was performed on each of the test pieces (in accordance with JIS K 7161) obtained in “2. Production of molded products of resin compositions.”

The test was performed on both of, for each division of the test pieces mentioned above, an unheated test piece immediately after molding and a heated test piece that, after molding, was subjected to a heat degradation test at 150° C. for 3000 hours.

In Table 1, the initial strength ratio (%) indicates the ratio of the tensile strength (the maximum tensile stress applied during the tensile test) of the unheated test piece in which a graphene oxide was added (Examples 1 to 3 and Comparative Example 2) on the assumption that the tensile strength of the unheated test piece in which a graphene oxide was not added (Comparative Example 1) is 100%.

Further, in Table 1, the strength retention rate (%) indicates the ratio of the tensile strength (the maximum tensile stress applied during the tensile test) of the heated test piece on the assumption that the tensile strength of the unheated test piece is 100%, in each division.

### 3-2. Evaluation of Joint Interface Properties of Resin-Metal Composites

A liquid gasket (an FIPG) of a silicone-based material was applied to an end surface of each of the unheated test pieces (in accordance with ISO 19095-3) obtained in “2. Production of molded products of resin compositions,” an aluminum piece was brought into contact with the application surface, and then the liquid gasket was cured; thus, adhesion test bodies for the evaluation of joint interface properties were prepared.

Each of the test bodies was fashioned into a butt-joined test piece in accordance with ISO 19095, and the joining (tensile) strength of the test body was found. The joining strength was found as the load (MPa) per unit volume of the joint on the occasion when the breaking of the joint occurred. The resulting values are indicated as the FIPG adhesiveness (MPa) in Table 1.

TABLE 1

| | Compar- | | | | Compar- |
|---|---|---|---|---|---|
| | ative Ex- | Example | Example | Example | ative Ex- |
| | ample 1 | 1 | 2 | 3 | ample 2 |
| Amoumt of | 0 | 0.1 | 1 | 3 | 10 |
| graphene oxide | | | | | |
| added (wt %) | | | | | |
| Initial strength | 100 | 100 | 99 | 95 | 80 |
| ratio (%) | | | | | |
| Strength | 60 | 96 | 99 | 92 | 70 |
| retention | | | | | |
| rate (%) | | | | | |
| FIPG | 17 | 28 | 30 | 28 | 20 |
| adhesiveness | | | | | |
| (MPa) | | | | | |

According to the implementation of the present invention, the resin composition is provided with heat stability and good adhesive performance to a silicone-based sealing material by a graphene oxide. Furthermore, the strength of a molded product after molding is not impaired. Therefore, when a molded product of the resin composition of the implementation of the present invention is used as a part of a vehicle, not only is the molded product itself excellent in heat resistance and strength, but also a joint structure having good joining strength to a framework member of the car body when the molded product is joined via a silicone-based sealing member can be provided.

Although the preferred implementations of the present invention have been described in detail herein, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

1. A resin composition comprising:
a polyamide resin; and
a graphene oxide.

2. The resin composition according to claim 1, wherein a degree of oxidation of the graphene oxide is more than or equal to 10% and less than or equal to 70%.

3. The resin composition according to claim 1, wherein a proportion of the graphene oxide blended is more than or equal to 0.1 mass % and less than or equal to 3 mass % relative to a total mass of the resin composition.

4. The resin composition according to claim 2, wherein a proportion of the graphene oxide blended is more than or equal to 0.1 mass % and less than or equal to 3 mass % relative to a total mass of the resin composition.

5. The resin composition according to claim 1, comprising fibers as a reinforcing material in a maximum amount of 60 mass % relative to the total mass of the resin composition.

6. The resin composition according to claim 2, comprising fibers as a reinforcing material in a maximum amount of 60 mass % relative to the total mass of the resin composition.

7. The resin composition according to claim 3, comprising fibers as a reinforcing material in a maximum amount of 60 mass % relative to the total mass of the resin composition.

8. The resin composition according to claim 4, comprising fibers as a reinforcing material in a maximum amount of 60 mass % relative to the total mass of the resin composition.

9. A molded product of the resin composition according to claim 1.

10. A molded product of the resin composition according to claim 2.

11. A molded product of the resin composition according to claim 3.

12. A molded product of the resin composition according to claim 4.

13. A joint structure of a molded product of a resin composition, wherein the molded product according to claim 9 and a member to be joined to the molded product are joined together via a cured substance of a liquid curable silicone rubber composition.

14. A joint structure of a molded product of a resin composition, wherein the molded product according to claim 10 and a member to be joined to the molded product are joined together via a cured substance of a liquid curable silicone rubber composition.

15. A joint structure of a molded product of a resin composition, wherein the molded product according to claim 11 and a member to be joined to the molded product are joined together via a cured substance of a liquid curable silicone rubber composition.

16. A joint structure of a molded product of a resin composition, wherein the molded product according to claim 12 and a member to be joined to the molded product are joined together via a cured substance of a liquid curable silicone rubber composition.

17. A coated body, wherein a surface of a molded object of a polyamide resin composition is coated with an outer skin material containing a graphene oxide.
